(19) United States
(12) Patent Application Publication
(10) Pub. No.: US 2007/0170176 A1
(43) Pub. Date: Jul. 26, 2007

(54) Composite tool bar

(75) Inventors: Dai Gil Lee, Daejeon (KR); Hui Yun Hwang, Daejeon (KR); Seung Min Lee, Daejeon (KR); Byung Chul Kim, Busan (KR)

Correspondence Address: BACON & THOMAS, PLLC, 625 SLATERS LANE, FOURTH FLOOR, ALEXANDRIA, VA, 22314, US

(73) Assignee: Korea Advanced Institute of Science and Technology, Daejeon (KR)

(21) Appl. No.: 10/573,159

(22) PCT Filed: Sep. 22, 2004
(86) PCT No.: PCT/KR04/02424

§ 371 Date: Jan. 22, 2007

(30) Foreign Application Priority Data
Sep. 23, 2003 (KR) 10-2003-0065971

(51) Int. Cl. H05B 6/10

(52) U.S. Cl. 219/645

(57) ABSTRACT

The present invention provides a composite tool bar which has a composite body part (10) covered with a covering (20), with a plurality of bites (TO1-T05) mounted on the composite body part (10) along a longitudinal direction. The composite tool bar includes a first insert (240) which is inserted into the composite body part (10). A bite mounting hole (210) is provided in the first insert (240) to receive a bite therein. A bite height adjusting hole (220) is axially aligned with the bite mounting hole (210) to receive therein a bite height adjusting bolt (BO1-B05). The composite tool bar further includes a second insert (250) which is inserted into the composite body part (10) to be coupled to the first insert (240). A bite holding hole (230) is provided in the second insert (250) to receive therein a bite holding bolt (B06-B10).

### TECHNICAL FIELD

The present invention relates, in general, to composite tool bars used in boring and reaming works and, more particularly, to a composite tool bar to which a bite is reliably mounted, and into which an insert is inserted to prevent deformation from occurring due to an asymmetrical structure in a post-process.

### BACKGROUND ART

Generally, tool bars are manufactured into longitudinal shapes to be used in boring and reaming works for machining holes in workpieces. Bites protrude on ends of the tool bars, such as a boring bar proposed in Korean Patent Laid-open Publication No. 1989-0011661 and made of a carbon fiber composite material.

However, the tool bar disclosed in Korean Patent Laid-open Publication No. 1989-0011661 uses a hollow shaft as a composite body part Therefore, it is very difficult to form a hole or tap for mounting a bite on a region of the composite body part other than the end thereof Thus, the above-mentioned conventional tool bar is not satisfactory in terms of machining accuracy and workability, which are important factors for machining tools.

In an effort to enhance the ability of conventional tool bars, a composite tool bar, in which a composite body part 10 is covered with a metal covering 20 as shown in FIGS. 1 and 2, was proposed in Korean Patent Laid-open Publication No. 2003-0009592 which was filed by the inventor of the present invention.

FIG. 1 is a perspective view of the conventional composite tool bar. FIG. 2 is a sectional view of the composite tool bar of FIG. 1 to show a bite coupling structure.

As shown in FIGS. 1 and 2, the composite tool bar disclosed in Korean Patent Laid-open Publication No. 2003-0009592 includes the composite body part 10 and the metal covering 20 to cover an outer surface of the composite body part 10. A plurality of holes are provided on the composite body part 10 along a longitudinal direction to receive therein bites (T01˜T05) and bolts (B01˜B10).

In detail, in the composite tool bar 100, bite mounting holes 110, into which the bites (T01˜T05) are inserted, and bite height adjusting holes 120, into which bite height adjusting bolts (B01˜B05) are inserted, are formed on the composite body part 10. As well, bite holding holes 130, into which bite holding bolts (B06˜B10) are inserted to hold the bites (T01-T05) at predetermined sides of the bite mounting holes 110, and a groove 160 to gather chips generated during a cutting process are formed on the composite body part 10.

However, in the composite tool bar 100 disclosed in Korean Patent Laid-open Publication No. 2003-0009592, a tap is formed on an inner surface of each of the bite holding holes 130 and the bite height adjusting holes 120 engaging with the bite height adjusting bolts (B01˜B10). Due to this structure, parts of the composite body part 10 on which the plurality of holes and taps are formed are brittle. Therefore, the conventional composite tool bar 100 is problematic in that the parts of the composite body part 10 on which the plurality of holes and taps are formed may be broken by engaging the bites (T01˜T05) and the bolts (B01˜B10) with the holes or by an outside force transferred during a cuing process.

Furthermore, in the composite tool bar 100 disclosed in Korean Patent Laid-open Publication No. 2003-0009592, the bite holding holes 130 are formed on only one side of the composite body part 10. As such, the composite body part 10 has an asymmetrical shape based on a longitudinal axis thereof. Accordingly, the conventional composite tool bar 100 is problematic in that mechanical deformation by cutting an outer surface of the metal covering 20 in a post-process or thermal deformation due to a difference in temperature may occur.

### BRIEF DESCRIPTION OF DRAWINGS

FIG. 1 is a perspective view of a conventional composite tool bar,

FIG. 2 is a sectional view of the composite tool bar of FIG. 1 to show a bite coupling structure;

FIG. 3 is a sectional view of a composite tool bar, to which a bite is coupled, according to an embodiment of the present invention;

FIGS. 4 and 5 are sectional views to show modifications of the composite tool bar of FIG. 3;

FIG. 6 is a sectional view of a composite tool bar, to which a bite is coupled, according to another embodiment of the present invention;

FIG. 7 is a sectional view to show a modification of the composite tool bar of FIG. 6;

FIG. 8 is a sectional view of a composite tool bar, to which a bite is coupled, according to a further embodiment of the present invention;

FIG. 9 is a sectional view to show a modification of the composite tool bar of FIG. 8;

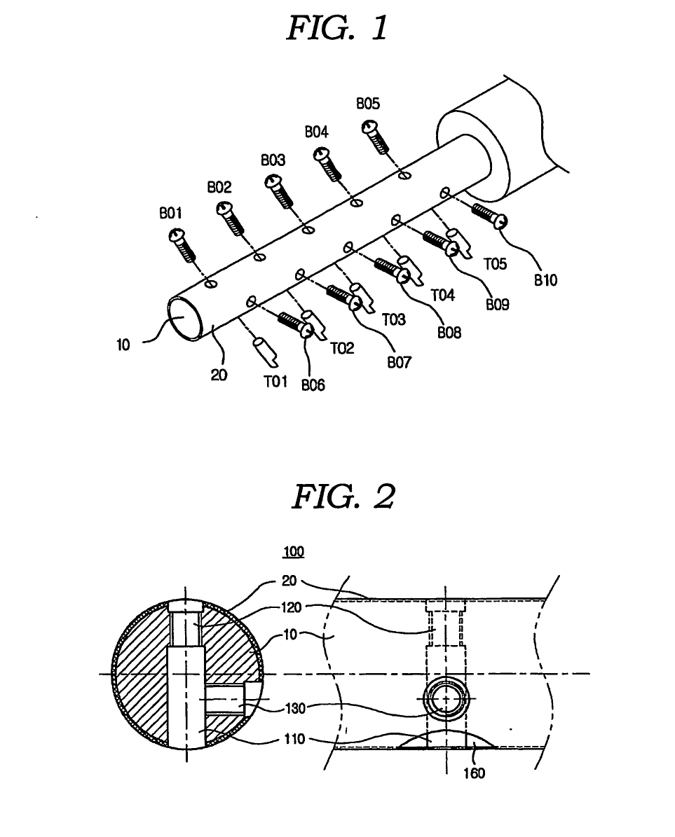

FIG. 1O is a sectional view of a composite tool bar, to which a bite is coupled, according to yet another embodiment of the present invention; and

FIG. 11 is a sectional view to show a modification of the composite tool bar of FIG. 10.

### DETAILED DESCRIPTION OF THE INVENTION

### Technical Problem

Accordingly, the present invention has been made keeping in mind the above problems occurring in the prior art and an object of the present invention is to provide a composite tool bar in which an insert to receive therein a bite is inserted at a predetermined position so as to soundly fasten the bite to the composite tool bar, thus preventing deformation and damage from occurring at a bite coupling region.

Another object of the present invention is to provide a composite tool bar in which an additional insert is inserted at a position symmetrical to a bite holding hole, thus preventing mechanical and thermal deformations from occurring due to an asymmetrical structure in a post-process.

### Technical Solution

In order to accomplish the above object(s), the present invention provides a composite tool bar having a composite body part covered with a covering, with a plurality of bites mounted on the composite body part along a longitudinal direction. The composite tool bar includes a first insert inserted into the composite body part while passing through the composite body part, with a bite mounting hole provided in the first insert to receive a bite therein, and a bite height adjusting hole axially aligned with the bite mounting hole in the first insert to receive therein a bite height adjusting bolt for adjusting a height of the bite inserted into the bite mounting hole; and a second insert inserted into the composite body part to be coupled to a first side of the first insert, with a bite holding hole provided in the second insert to receive therein a bite holding bolt

### Advantageous Effect

In the composite tool bar according to the present invention, an insert made of a predetermined material having high hardness is inserted into a composite body part A bite is fitted into a hole provided in the insert Therefore, the bite does not undesirably move and a bite mounting part is not broken, thus increasing the workability of the bite.

Furthermore, in the present invention, an additional insert may be provided at a predetermined position to be diametrically opposite to a second insert or, alternatively, the second insert, into which a bite holding bolt is inserted, may be positioned at the center of the composite tool bar. As a result, mechanical deformation and thermal deformation occurring due to an asymmetrical structure is not caused.

### Best Mode

Hereinafter, composite tool bars having bites according to embodiments of the present invention will be described in detail with reference to the accompanying drawings.

### FIRST EMBODIMENT

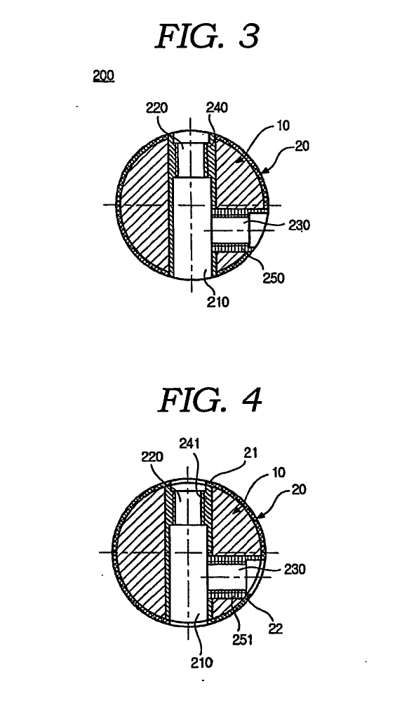

FIG. 3 is a sectional view of a composite tool bar, to which a bite is coupled, according to a first embodiment of the present invention. FIGS. 4 and 5 are sectional views to show modifications of the composite tool bar of FIG. 3.

As shown in FIGS. 3 through 5, in the composite tool bar 200 according to the present invention, a metal covering 20 is using a bonding agent attached to, or interference fitted over a very stiff outer surface of a composite body part 10.

A first insert 240, which is made of a metal having a high hardness or another predetermined material, is inserted into the composite tool bar 200 of the present invention in a transverse direction to cross a longitudinal axis of the composite tool bar 200. A second insert 250, which is made of the same material as that of the first insert 240, is coupled to a predetermined side of the first insert 240.

Here, the first and second inserts 240 and 250 are inserted into and fastened to the composite body part 10 using bonding agents or through interference fitting processes. In detail, the bonding agent is previously applied to an outer surface of each of the first and second inserts 240 and 250 or an inner surface of each of the insert holes of the composite body part 10. Thereafter, the first and second inserts 240 and 250 are inserted into the insert holes which relate to them. Here, the surfaces of the first and second inserts 240 and 250 and the insert holes of the composite body part 10 may be treated by chemicals, such as nitric acid or phosphoric acid, or may be mechanically treated using sandpaper, before the bonding agent is applied. Then, more satisfactory coupling is obtained (preferably, in the case of the mechanical surface treatment, an average roughness of the surfaces of the inserts and the insert holes of the composite body part ranges from 1.0 mm to 3.0 mm).

Alternatively, each of the first and second inserts 240 and 250 have an outer diameter smaller than a diameter of the insert hole of the composite body part 10 which relates to it Thus, each of the first and second inserts 240 and 250 may be fastened to the insert hole of the composite body part 10, which relates to it, through the interference fitting process.

The first insert 240 has a bite mounting hole 210 to receive therein a bite (T01˜T05), and a bite height adjusting hole 220 which is axially aligned with the bite mounting hole 210 to receive therein a bite height adjusting bolt (B01˜B05) for adjusting a height of the bite (B01˜B05) inserted into the bite mounting hole 210. The bite height adjusting hole 220 of the first insert 240 is tapped for engagement with the bite height adjusting bolt (B01˜B05) (see, FIGS. 1 and 3).

A bite holding hole 230 is provided in the second insert 250 to receive therein a bite holding bolt (B06˜B10) which holds the bite (T01˜T05). The bite holding hole 230 is taped for engagement with the bite height adjusting bolt (B06˜B10).

As described above, the first and second inserts 240 and 250, each of which is made of metal or another very hard material, are inserted into and securely fastened to the composite body part 10 using bonding agents or through an interference fitting process. The bite (T01˜T05) is held by the bolts (B01˜B10) in the inserts. Therefore, even though the composite tool bar 100 of the present invention, to which the bite (T01˜T05) is mounted, is affected by outside force during a repeated cutting process, screw threads of the bite height adjusting hole 220 and the bite holding hole 230 of the first and second inserts 240 and 250 are not easily worn or broken, and the bite (T01˜T05) is not undesirably removed from the first insert 240.

A method for manufacturing the composite too bar 200 is as follows.

First the composite body part 10 is covered with the metal covering 20. The insert holes are formed on the composite tool bar 200 to receive the first and second inserts 240 and 250 therein. Thereafter, the first and second inserts 240 and 250 are sequentially inserted into and fastened to the insert holes which relate to them, using the bonding agents or through the interference fitting processes. The bite mounting hole 210, the bite height adjusting hole 220 and the bite holding hole 230 may be formed in the first and second inserts 240 and 250 after the first and second inserts 240 and 250 are inserted into the insert holes. Alternatively, they may be formed in the first and second inserts 240 and 250 before the first and second inserts 240 and 250 are inserted into the insert holes.

The composite tool bar shown in FIG. 4 is manufactured by a method different from the composite tool bar 200 of FIG. 3.

In detail, insert holes are formed on a composite body part 10 to receive first and second inserts 241 and 251 therein The first and second inserts 241 and 251 are inserted into and fastened to the insert holes, which relate to them, using bonding agents or through interference fitting processes. Thereafter, a metal covering 20 is using a bonding agent attached to, or interference fitted over an outer surface of the composite body part 10. A bite mounting hole 210, a bite height adjusting hole 220 and a bite holding hole 230 are formed on predetermined positions on which the first and second inserts 241 and 251 are formed.

The composite tool bar of FIG. 4 has the same structure and operation as those of the composite tool bar 200 of FIG. 3. However, parts 21 and 22 of the metal covering 20 cover parts of ends of the first and second inserts 241 and 251, unlike the composite tool bar of FIG. 3. Therefore, in the composite tool bar of FIG. 4, the first and second inserts 241 and 251 are firmly mounted in the composite body part 10 by the support of the metal covering 20 surrounding the first and second inserts 241 and 251.

As shown in FIG. 5, in the present invention, a metal covering 20′, provided in a bite mounting region thereof on which insert holes are formed, may have a predetermined thickness smaller than the metal covering 20 provided on other regions of the composite tool bar 200. Thus, the composite tool bar 200 has in the bite mounting region thereof a predetermined outer diameter smaller than that of the other regions. Therefore, the metal covering 20′ of the bite mounting region is prevented from being processed in a post-process in that the outer surface of the composite tool bar 200 is processed.

### SECOND EMBODIMENT

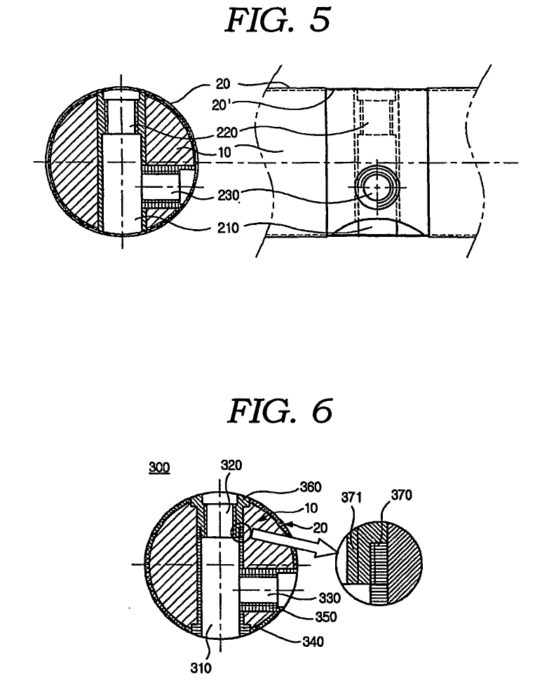

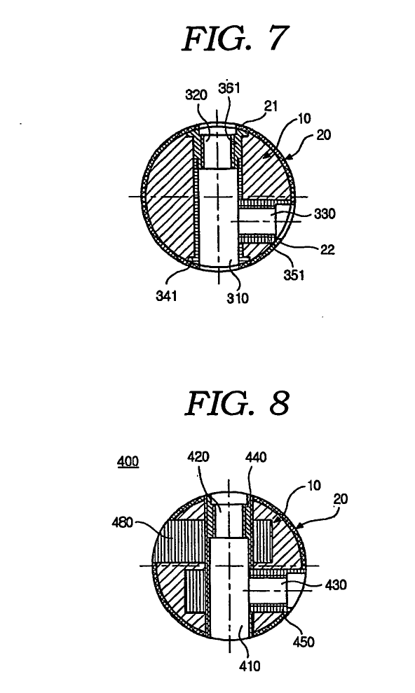

FIG. 6 is a sectional view of a composite tool bar, to which a bite is coupled, according to a second embodiment of the present invention. FIG. 7 is a sectional view to show a modification of the composite tool bar of FIG. 6.

In the composite tool bar 300 according to the second embodiment shown in FIGS. 6 and 7, a first insert 340, on which a bite mounting hole 310 is formed, and a third insert 360, on which a bite height adjusting hole 320 is formed, are coupled to each other, thus executing the same role as the first insert 240 of the first embodiment

In a detailed description, the first insert 340 having therein the bite mounting hole 310 has at a first end thereof a predetermined diameter wider than an average diameter thereof like a shape of a round flat head screw. An outer surf of a second end 370 of the first insert 340 is tapped The third insert 360 having therein the bite height adjusting hole 320 has a predetermined diameter wider than an average diameter thereof in a shape similar to that of the first insert 340 like the shape of the round flat head screw. An outer surface of a second end 371 of the third insert 360 is tapped to engage with the second end of the first insert 340. The first and third inserts 340 and 360 are inserted into an insert hole of a composite body part 10 of the composite tool bar 300 such that the second ends 370 and 371 of them engage with each other.

A method for manufacturing the composite tool bar 300 is as follows.

First a metal covering 20 is using a bonding agent attached to, or interference fitted over an outer surface of the composite body part 10. The insert hole is formed on the composite body part 10 to receive the first and third inserts 340 and 360 therein. Thereafter, the first insert 340, which has therein the bite mounting hole 310 and is tapped at the outer surface of the second end 370 thereof, and the third insert 360, which has therein the bite height adjusting hole 320 and is tapped at the outer surface of the second end 371 thereof, are tightened into the insert hole in opposite directions. That is, the second ends 370 and 371 of the first and third inserts 340 and 360 engage with each other. The first ends of the first and third inserts 340 and 360, which are wide in diameter, are stopped by the composite body part 10. Thus, the first and third inserts 340 and 360 are firmly fastened to the insert hole. Thereafter, another insert hole is formed on the composite body part 10 to receive a second insert 350 therein. The second insert 350 having therein a bite holding hole 330 is inserted into and fastened to this insert hole using a bonding agent or through an interference fitting process.

A composite tool bar shown in FIG. 7 is manufactured by a method different from the composite tool bar 300 of FIG. 6.

In detail, an insert hole is formed on a composite body part 10 to receive first and third inserts 341 and 361 therein. The first and third inserts 341 and 361, each of which is tapped at an end thereof, are inserted into the insert hole. Thereafter, another insert hole is formed on a side of the first end 341 to receive a second insert 351 therein. The second insert 351 is inserted into and fastened to this insert hole using a bonding agent or through an interference fitting process.

As such, after the plurality of inserts are inserted, an outer surface of the composite body part 10 is covered with the metal covering 20. A bite mounting hole 310, a bite height adjusting hole 320 and the bite holding hole 330 are formed through the metal covering 20.

The composite tool bar of FIG. 7 has the same structure and operation as those of the composite tool bar 300 of FIG. 6. However, parts 21 and 22 of the metal covering cover parts of ends of the first and second inserts 341 and 351, unlike the composite tool bar of FIG. 3. Therefore, in the composite tool bar of FIG. 7, the first, second and third inserts 341, 351 and 361 are firmly mounted in the composite body part 10 by the support of the metal covering 20 surrounding the first, second and third inserts 341,351 and 361.

Hereinafter, technique preventing deformation from occurring during the machining process due to residual stress resulting from the asymmetrical bite coupling structure or the coupling of different materials in the composite tool bar will be described.

### THIRD EMBODIMENT

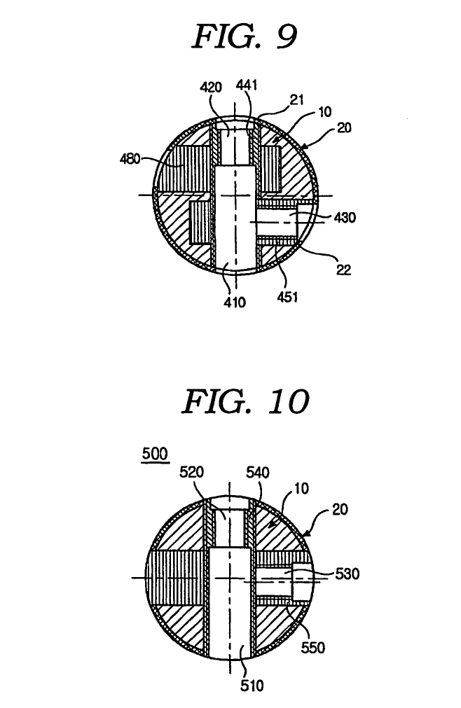

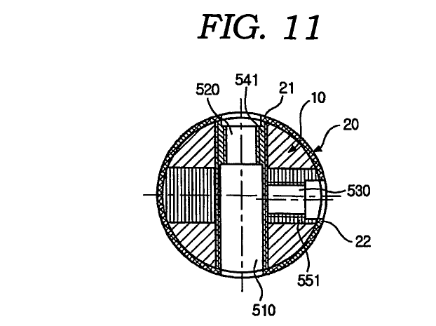

FIG. 8 is a sectional view of a composite tool bar, to which a bite is coupled, according to a third embodiment of the present invention. FIG. 9 is a sectional view to show a modification of the composite tool bar of FIG. 8.

In the composite tool bar 400 according to the third embodiment shown in FIGS. 8 and 9, an additional insert 480 is provided at a predetermined position to be diametrically opposite to a second insert 450 having a bite holding hole 430. Thus, even when the composite tool bar 400 rotates quickly during the machining process, mechanical deformation and thermal deformation occurring due to an asymmetrical structure do not occur.

A method for manufacturing the composite too bar 400 of FIG. 8 is as follows.

First, a metal covering 20 is using a bonding agent attached to, or interference fitted over an outer surface of the composite body part 10. An insert hole for insertion of the second insert 450, and another insert hole for insertion of the additional insert 480 are formed at predetermined positions of the composite body part 10 to be diametrically opposite to each other based on a longitudal axis of the composite body part 10.

Thereafter, the second insert 450 and the additional insert 480 are inserted into and fastened to the insert holes which relate to them, using bonding agents or through an interference fitting process. An insert hole for insertion of a first insert 440 is thereafter formed on the composite body part 10. An inner surface of this insert hole is tapped.

Next, the first insert 440, an outer surface of which is tapped, engages with the insert hole that relates to it. In the composite tool bar 400, bonding agents may be applied to both the outer surface of the first insert 440 and the inner surface of the insert hole to fastened the first insert 440 to the insert hole more firmly. Furthermore, both a bite mounting hole 410 and a bite height adjusting hole 420 may be formed on the first insert 440 after the first insert 440 is inserted into the composite tool bar. Alternatively, they may be formed on the first insert 440 before the first insert 440 is inserted into the composite tool bar. The composite tool bar shown in FIG. 9 is manufactured by a method different from the composite tool bar 400 of FIG. 8.

First, insert holes for insertions of a second insert 451 and an additional insert 480 are formed on a composite body part 10. Thereafter, the second insert 451 and the additional insert 480 are inserted into and fastened to the insert holes that relate to them, using bonding agents or through interference fitting processes. Next an insert hole for insertion of a first insert 441 is formed on the composite body part 10. An inner surface of this insert hole is tapped. Thereafter, the first insert 441 of which an outer surface is tapped is tightened into the tapped insert hole. The composite body part 10 is, thereafter, covered with a metal covering 20. A bite mounting hole 410, a bite height adjusting hole 420 and a bite holding hole 430 are formed at predetermined positions through the metal covering 20.

The composite tool bar of FIG. 9 has the same structure and operation does of the composite tool bar 400 of FIG. 8. However, parts 21 and 22 of the metal covering cover parts of ends of the first and second inserts 441 and 451, unlike the composite tool bar of FIG. 8. Therefore, in the composite tool bar of FIG. 9, the first and second inserts 441 and 451 are firmly mounted in the composite body part 10 by the support of the metal covering 20 surrounding the first and second inserts 441 and 451.

### FOURTH EMBODIMENT

FIG. 10 is a sectional view of a composite tool bar, to which a bite is coupled, according to a fourth embodiment of the present invention. FIG. 11 is a sectional views to show a modification of the composite tool bar of FIG. 10.

In the composite tool bar 500 shown in FIGS. 10 and 11, a second insert 550, on which a bite holding hole 530 is formed, is inserted into the composite tool bar 500 to be perpendicular to a first insert, on which both a bite mounting hole 510 and a bite height adjusting hole 520 are formed, at the center of a cross-section of the composite tool bar 500. Thus, the second insert 550 is symmetrical with respect to the center of the composite tool bar 500. In this case, the bite holding hole 530, into which a bite holding bolt (B05˜B10) is tightened, is formed away from the center axis of the composite tool bar 500 to allow the bite to be securely held. Therefore, it is preferable that a diameter of the second insert 550 be larger than that of the second inserts 250, 350 and 450 of the first through third embodiments. Due to the above-mentioned structure, even when the composite tool bar 500 speedily rotates during the machining process, mechanical deformation and thermal deformation occurring due to an asymmetrical structure are not caused.

A method for manufacturing the composite tool bar 500 shown in FIG. 10 is similar to that of the composite tool bar 400 of the third embodiment shown in FIG. 8, and it is as follows.

First a metal covering 20 is using a bonding agent attached to, or interference fitted over an outer surface of a composite body part 10. An insert hole for insertion of the second insert 550 is formed on the composite body part 10. The second insert 550 is inserted into and fastened to this insert hole using a bonding agent or through an interference fitting process. Thereafter, another insert hole for insertion of the first insert 540 is formed at a predetermined position on the composite tool bar 500 to be perpendicular to the second insert 550 at the center axis of the composite tool bar 500 while being symmetrical with respect to the center of the composite tool bar 500. This insert hole is tapped.

Next, the first insert 540, an outer surface of which is tapped, engages with the insert hole which relates to it In the composite tool bar 500, bonding agents may be applied to both the outer surface of the first insert 540 and the inner surface of the insert hole to fasten the first insert 540 to the insert hole more firmly. Furthermore, both a bite mounting hole 510 and a bite height adjusting hole 520 may be formed on the first insert 540 after the first insert 540 is inserted into the composite tool bar. Alternatively, they may be formed on the first insert 540 before the first insert 540 is inserted into the composite tool bar.

A method for manufacturing the composite tool bar shown in FIG. 11 is similar to that of the composite tool bar of the third embodiment shown in FIG. 9, but it differs from the method for manufacturing the composite tool bar 500 of FIG. 10.

In a detail description, an insert hole for insertion of a second insert 551 is formed in a composite body part 10. Thereafter, the second insert 551 is inserted into and fastened to the insert hole that relates to it, using a bonding agent or through an interference process. Next another insert hole for insertion of a first insertion 541 is formed in the composite tool bar to be perpendicular to the second insert 550 at the center axis of the composite tool bar. An inner surface of this insert hole is tapped. Thereafter, the first insert 541, an outer surface of which is tapped, is tightened into the tapped insert hole. The composite body part 10 is, thereafter, covered with a metal covering 20. A bite mounting hole 510, a bite height adjusting hole 520 and a bite holding hole 530 are formed at predetermined positions through the metal covering 20.

The composite tool bar of FIG. 11 has the same structure and operation as does the composite tool bar 500 of FIG. 10. However, parts 21 and 22 of the metal covering cover parts of ends of the first and second inserts 541 and 551, unlike the composite tool bar of FIG. 10. Therefore, in the composite tool bar of FIG. 11, the first and second inserts 541 and 551 are firmly mounted in the composite body part 10 by the support of the metal covering 20 surrounding the first and second inserts 541 and 551.

Although the composite tool bar of the present invention has been disclosed with the accompanying drawings for illustrative purposes, it only shows preferred embodiments of the present invention, and does not limit the present invention In addition, those skilled in the art will appreciate that various modifications, additions and substitutions are possible, without departing from the scope and spirit of the invention as disclosed in the accompanying claims.

1. A composite tool bar having a composite body part covered with a covering, with a plurality of bites mounted on the composite body part along a longitudinal direction, the composite tool bar comprising:
a first insert inserted into the composite body part while passing through the composite body part, with a bite mounting hole provided in the first insert to receive a bite therein, and a bite height adjusting hole axially aligned with the bite mounting hole in the first insert to receive therein a bite height adjusting bolt for adjusting a height of the bite inserted into the bite mounting hole; and
a second insert inserted into the composite body part to be coupled to a first side of the first insert, with a bite holding hole provided in the second insert to receive therein a bite holding bolt.

2. The composite tool bar according to claim 1, wherein the first insert is fitted into and fastened to an insert hole, formed through both the composite body part and the covering, using a bonding agent or through an interference fitting process.

3. The composite tool bar according to claim 1, wherein the first insert is tapped on an outer surface thereof, and an insert hole formed through both the composite body part and the covering is tapped on an inner surface thereof to correspond to the tapped first insert, so that the first insert is tightened into the insert hole.

4. The composite tool bar according to claim 3, further comprising:
a bonding agent applied to the outer surface of the first insert or the inner surface of the insert hole.

5. The composite tool bar according to claim 1 or 3, further comprising:
an additional insert inserted into a predetermined position of the composite body part to be diametrically opposite to the second insert based on a longitudinal axis of the composite body part.

6. The composite tool bar according to claim 1 or 3, wherein the second insert extends to a second side of the first insert to perpendicularly cross to the first insert at a longitudinal axis of the composite body part.

7. The composite tool bar according to any one of claims 1 through 3, wherein the covering covers ends of both the first insert and the second insert, thus preventing the ends of the inserts from being exposed outside.

8. A composite tool bar having a composite body part covered with a covering, with a plurality of bites mounted on the composite body part along a longitudinal direction, the composite tool bar comprising:
a first insert inserted into the composite body part, with a bite mounting hole provided in the first insert to receive a bite therein, the first insert having at a first end thereof a predetermined diameter wider than an average diameter thereof like a shape of a screw and being tapped on an outer surface of a second end thereof, a second insert coupled to a predetermined side of the first insert, with a bite holding hole provided in the second insert to receive therein a bite holding bolt; and
a third insert, with a bite height adjusting hole provided in the third insert to receive therein a bite height adjusting bolt for adjusting a height of the bite inserted into the bite mounting hole, the third insert having, at a first end thereof; a predetermined diameter wider than an average diameter thereof like a shape of a screw and being tapped at a second end thereof to engage with the second end of the first insert, thus being inserted into the composite body part to be axially aligned with the first insert in a direction opposite to the first insert

9. The composite tool bar according to claim 8, wherein the covering covers ends of the first, second and third inserts, thus preventing the ends of the inserts from being exposed outside.

10. The composite tool bar according to claim 1 or 8, wherein the covering has a predetermined outer diameter in a bite mounting region thereof, on which both the bite height adjusting hole and the bite holding hole are formed, smaller Man an outer diameter in another region thereof, which has no hole, thus preventing the covering from being processed in a post-process.
